(19) United States
(12) Patent Application Publication
(10) Pub. No.: US 2012/0278257 A1
(43) Pub. Date: Nov. 1, 2012

(54) METHOD FOR FINANCIAL INSTRUMENT VALUATIONS BASED ON PRIMARY DATA AND MINIMUM BASE AVERAGE VALUE OF FINANCIAL ASSETS

(76) Inventor: Geraldine Marie Lettieri, Brightwaters, NY (US)

(21) Appl. No.: 13/456,222

(22) Filed: Apr. 26, 2012

Related U.S. Application Data
(60) Provisional application No. 61/479,545, filed on Apr. 27, 2011.

(51) Int. Cl. G06Q 40/06

(52) U.S. Cl. 705/36 R

(57) ABSTRACT

A data system and minimum base average value (MBAV) is accurate, verifiable and based on actual market conditions as well as trade data. The system has the cumulative effect of achieving accurate financial instrument valuations that support government, institutional and investor financial investments in a positive, stable way. No longer does a portfolio need to take a percentage hit almost overnight due to some random and/or questionable, or worse still, no valuation process being used in valuations. Without a definitive MBAV, billions of dollars of investment and investor money can “disappear” or be removed by false valuations, literally overnight.

### CROSS-REFERENCE TO RELATED APPLICATIONS

This application claims the benefit of priority of U.S. provisional patent application No. 61/479,545, filed Apr. 27, 2011, the contents of which are herein incorporated by reference.

### BACKGROUND OF THE INVENTION

The present invention relates to a financial instrument investment data valuation system and, more particularly, to an investment valuation system providing a minimum base average value (MBAV) for a given financial instrument that is traded.

Financial investments have been key to the accumulation as well as preservation of wealth. Critical to this accumulation and preservation is correct and stable valuations, by government, financial institutions, pension funds, insurance companies as well as other interested parties.

As time passes and economic conditions change, accurate and stable valuations can become eroded, modified or disappear altogether, to the detriment of any investor, government and institution large and small.

With the predominance of computer driven systems in finance, headed by computer and information technology (IT) trained individuals who may have limited knowledge of finance, or even correct and proper methods of accurate valuations, all may have helped to cause accurate valuations to disappear. Frequently, a sole IT individual is left to program whatever he deems proper for valuations, without any regard to actual market conditions or trade data.

Even “in house” valuations are left to whatever the individual in charge thinks is correct or expedient. Their “haphazard” valuations cannot be explained by actual market conditions or trade data.

As can be seen, there is a need for an improved method for accurately valuating financial instruments, thus promoting accuracy and stability for inventors and issuers.

### SUMMARY OF THE INVENTION

In one aspect of the present invention, a computer-implemented method, written as a programmable code, stored on a computer readable medium, and adapted to valuate a financial instrument, wherein the method comprises receiving raw trade data from a specific type of financial instrument; filtering the raw trade data into usable fields, the usable fields including at least one of time, size, and price; calculating a minimum base average value for the financial instrument; and distributing a valuation to a recipient.

In another aspect of the present invention, a method for valuating a financial instrument comprises receiving raw trade data from a specific type of financial instrument; filtering the raw trade data into usable fields, the usable fields including at least one of time, size, and price; calculating a minimum base average value for the financial instrument; and distributing a valuation to a recipient.

In a further aspect of the present invention, a computer-implemented method, written as a programmable code, stored on a computer readable medium, and adapted to valuate a financial instrument, wherein the method comprises receiving raw trade data from a specific type of financial instrument; sorting the raw trade data into separate fields; filtering the raw trade data into usable fields, the usable fields including at least one of time, size, and price; calculating a minimum base average value for the financial instrument; applying the minimum base average value to each of the financial instruments; and distributing a valuation to a recipient.

These and other features, aspects and advantages of the present invention will become better understood with reference to the following drawings, description and claims.

### BRIEF DESCRIPTION OF THE DRAWINGS

FIG. 1 is a schematic representation of a system for valuating financial data according to an exemplary embodiment of the present invention;

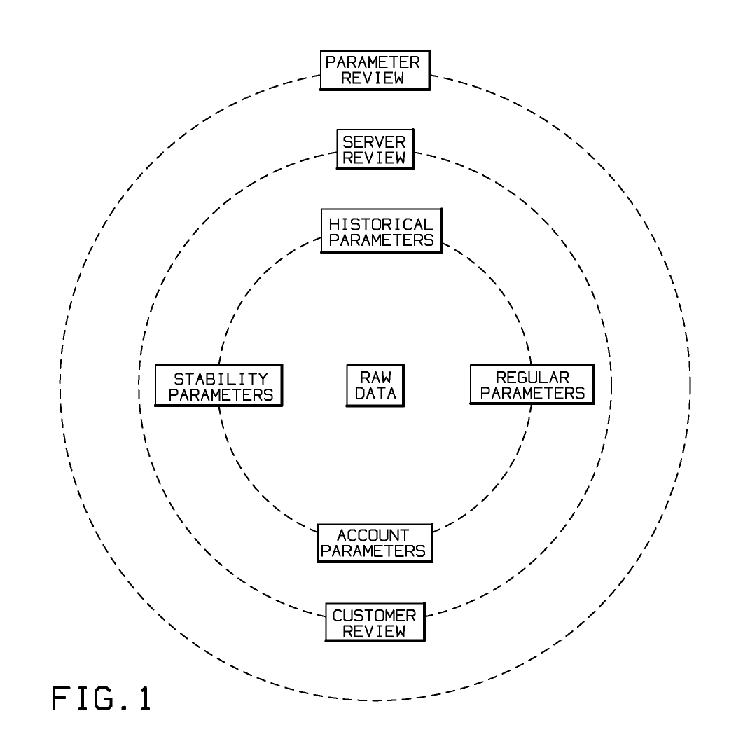

FIG. 2 is a algorithmic schematic representation of the system of FIG. 1; and

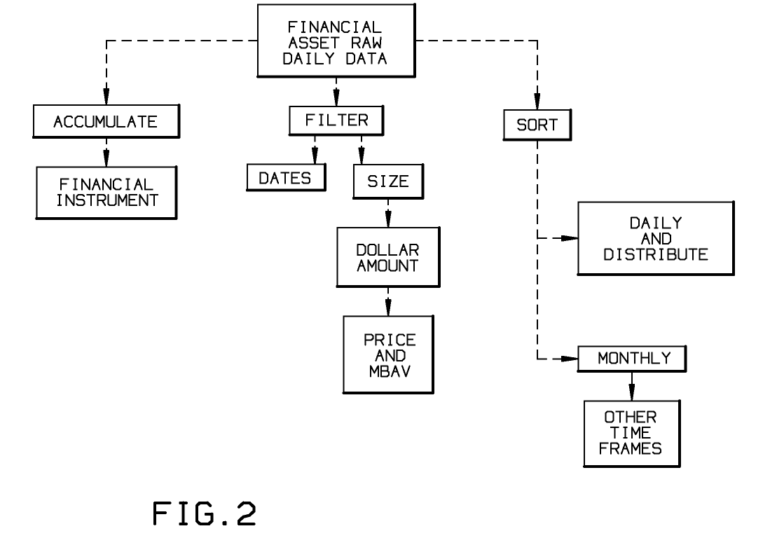

FIG. 3 is a flow chart describing a method for valuating financial data according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a data system and minimum base average value (MBAV) which is accurate, verifiable and based on actual market conditions as well as trade data. The system has the cumulative effect of achieving accurate financial instrument valuations that support government, institutional and investor financial investments in a positive, stable way. No longer does a portfolio need to take a percentage hit almost overnight due to some random and/or questionable, or worse still, no valuation process being used in valuations. Without a definitive MBAV, billions of dollars of investment and investor money can “disappear” or be removed by false valuations, literally overnight.

As used herein, the term “minimum base average value (MBAV) refers to the bottom line price that a particular financial instrument should be valued for a set time, such as daily, monthly, or the like.

To achieve the objective of correct valuations in financial products, the present invention provides a financial MBAV by integrating synergistically a raw data retrieval system, a sophisticated series of filters, including size, dates, dollar amount, price, and the like, and an accurate computing module to provide a dynamic link to the minimum average daily price value per each individually traded item, that is the MBAV. This allows the government, financial institutions, and even individual investors to understand what the lowest, correct average value for that specific financial issue is for that day or whatever time frame is desired or needed. This value can also be used for dealer pricing calculations.

The present invention also provides a means of monitoring and filtering data for numerous purposes. Normal and unusual trading patterns can be filtered, as well as questionable trades in terms of timing and/or pricing can be flagged. This system also includes dynamic tracking, filtering, as well as custom filtering.

There are no percentages or historical graphs, or out-of-market data applied to this data. There is no need for “standard deviations” or other opaque parameters and methods. For all of the foregoing reasons, the data and MBAV is therefore a true average value according to the real current market.

The system of the present invention may be a computer based system operating based on computer software. The software of the present invention may be written in any one or more programming languages. In some embodiments, the software may be designed to operate on a computer system, having a central processing unit, memory and other typical computer components. In some embodiments, the software may reside on a server and operate on various computers or computer terminals. In some embodiments, the software may reside at least partially on a server or cloud-based system or on an internet-based system, where the raw data may be interchanged with the software of the present invention. Security measures may be included with the software, such as data encryption, to permit the secure exchange of information between the software and users.

The software of the present invention may include computer code, disposed on a computer readable medium, adapted to perform the various functions as described herewithin. The software of the present invention may be capable of retrieving raw data, such as government data, and transforming that data into accurate financial instrument (bonds, stocks, ETF's, any derivative, and the like) valuation.

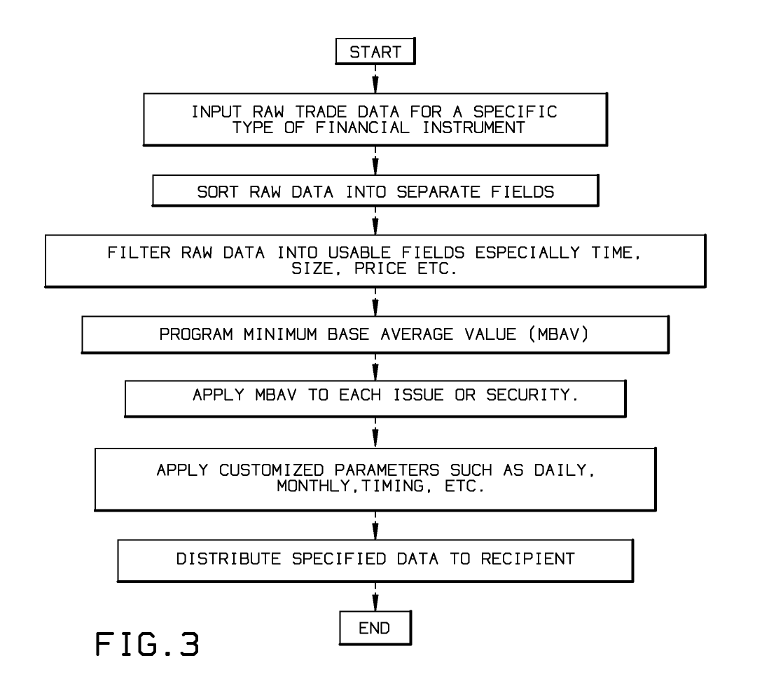

Referring to FIG. 3, steps in a method to valuate financial instruments includes one or more of the following steps: a) receiving raw trade data from a specific type of financial instrument; b) sorting the raw trade data into separate fields; c) filtering the raw trade data into usable fields, the usable fields including at least one of time, size, and price; d) calculating a minimum base average value for the financial instrument; e) applying the minimum base average value to each of the financial instruments; and f) distributing a valuation to a recipient.

Once hooked up, each subscriber can obtain and apply the correct daily and monthly values to any possible investment/portfolio involving U.S. securities. The present invention may also be useful for pricing securities as well. Moreover, the present invention can filter data in numerous ways for monitoring, comparisons, as well as for legal and security monitoring. The data generated by the methods of the present invention may be applied directly to trade servers, it may be transmitted by facsimile, it may be printed on copy machines, it may be stored, limited amounts of data may even be accessed by phone devices, and other means may be contemplated within the scope of the present invention to access the data generated by the methods of the present invention.

It should be understood, of course, that the foregoing relates to exemplary embodiments of the invention and that modifications may be made without departing from the spirit and scope of the invention as set forth in the following claims.

What is claimed is:

1. A computer-implemented method, written as a programmable code, stored on a computer readable medium, and adapted to valuate a financial instrument, the method comprising:
receiving raw trade data from a specific type of financial instrument;
filtering the raw trade data into usable fields, the usable fields including at least one of time, size, and price;
calculating a minimum base average value for the financial instrument; and
distributing a valuation to a recipient.

2. The method of claim 1, further comprising sorting the raw trade data into separate fields.

3. The method of claim 1, further comprising applying the minimum base average value to each of the financial instruments.

4. The method of claim 1, wherein the step of filtering includes removing out of date trades from the raw trade data.

5. The method of claim 2, wherein the separate fields include at least one of financial instrument identifier, description, size of trade, price of trade, and percentage return.

6. A method for valuating a financial instrument, the method comprising:
receiving raw trade data from a specific type of financial instrument;
filtering the raw trade data into usable fields, the usable fields including at least one of time, size, and price;
calculating a minimum base average value for the financial instrument; and
distributing a valuation to a recipient.

7. The method of claim 6, wherein the step of filtering includes removing out of date trades from the raw trade data.

8. The method of claim 7, wherein the usable fields include at least one of financial instrument identifier, description, size of trade, price of trade, and percentage return.

9. A computer-implemented method, written as a programmable code, stored on a computer readable medium, and adapted to valuate a financial instrument, the method comprising:
receiving raw trade data from a specific type of financial instrument;
sorting the raw trade data into separate fields;
filtering the raw trade data into usable fields, the usable fields including at least one of time, size, and price;
calculating a minimum base average value for the financial instrument;
applying the minimum base average value to each of the financial instruments; and
distributing a valuation to a recipient.

10. The method of claim 9, wherein the step of filtering includes removing out of date trades from the raw trade data.
